(19) United States
(12) Patent Application Publication
(10) Pub. No.: US 2003/0164333 A1
(43) Pub. Date: Sep. 4, 2003

(54) In-line hydration pack biological filter

(76) Inventors: John E. Nohren JR., St. Petersburg, FL (US); Bradley D. Mierau, Tampa, FL (US); John T. Smith, Dunedin, FL (US); Robert S. McLennan, Port Richey, FL (US)

Correspondence Address: NIXON & VANDERHYE, PC, 1100 N GLEBE ROAD, 8TH FLOOR, ARLINGTON, VA, 22201-4714, US

(21) Appl. No.: 10/364,654

(22) Filed: Feb. 12, 2003

Related U.S. Application Data
(60) Provisional application No. 60/355,756, filed on Feb. 12, 2002.

(51) Int. Cl. B01D 63/00

(52) U.S. Cl. 210/650; 210/321.6

(57) ABSTRACT

A portable filtration assembly includes a housing containing a water inlet port and a water outlet port and a sub-micron filter disposed in the housing having hydrophilic sub-micron rated membrane filter elements. The sub-micron filter is configured to effect a six log reduction of bacteria (99.9999%) and a four log reduction of protozoa (99.99%) at a flow rate between 10-30 mL/sec requiring a pressure of 1.5-10 psi. The assembly also includes structure for venting air through the hydrophilic sub-micron rated membrane filter elements. The assembly may additionally include a monolithic radial flow carbon composite filter also disposed in the housing. The monolithic radial flow carbon composite filter is configured for removing at least 80% of chlorine and at least 90% of lead over a minimum of forty gallons at a flow rate of 10 mL/sec at a pressure drop of 10 psi or less.

### CROSS-REFERENCES TO RELATED APPLICATIONS

This application claims the benefit of U.S. Provisional Patent Application Serial No. 60/355,756, filed Feb. 12, 2002, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The need to treat water in an economical and convenient manner for biological contamination by individuals engaged in a variety of sports activities and in the military has long been recognized. The need has also been recognized in times of natural disasters, and at times, municipal water supplies require treatment by the consumer. Particularly, these users have a need to adapt hydration packs, canteens, and other water containers to a complementing biological water treatment device that can be used in a variety of ways, which can vary between use with a container at a camp site but primarily stays with or is worn by the user. Typically, the water is treated as it is consumed, but the device may alternatively be used to treat water remotely, for example from one container to another using gravity and or suction developed by a siphon, or a pump as the means for transporting the water through the filtration-treatment device. It is also desirable to incorporate the biological water treatment device with a means to pump the water through the filter, which could be used to implement removal of water from a stream into the container of choice or to deliver water to an overly fatigued user.

While technology allowing filtration of microorganisms from raw water in an independent pump activated device has been available, all such units are used to treat a volume of water that is then transferred to a container from which the treated water is taken. These units never treat the water on a demand basis, treating the water as consumed, as the subject of this patent does. There are a number of serious inadequacies, which limit the application of microbial filters in the pump type products. For the removal of protozoan cysts from water an effective pore size between 1 and 3 microns in the filtration medium is recommended, while for retention of bacteria particles an order of magnitude smaller, into the sub-micron range of 0.1-0.3 must be excluded.

Filtration media possessing the capability to exclude particles in this size range are relatively dense (possessing a relatively small pore volume with a large cross section), inhibiting the flow of water through the media, as well as the material to be filtered. In some filters the resistance to flow has necessitated the use of pumps to exert sufficient pressure to effect water transfer across the filter media. The result is somewhat heavy units, which are clumsy and awkward to use. The dilemma that has existed in designing small filters that are effective at removing bacteria and cysts has been that the pressure drop per unit surface area is large, while the available surface area is small.

Typically, the preferred means of low micron filtration has been through the use of monolithic ceramic filters possessing fairly thick sidewalls, from 0.125 to 0.250 inches (3.175-6.35 mm). It is also difficult to maintain pore size control, and a larger pore size is necessary just to obtain flow under relatively high pressure as a result of the wall and non-linear path through the ceramic or carbon composite matrix. Thus, the filter relies to a large degree upon its depth (wall thickness) to trap the contaminant. This works well to filter out protozoa cysts, which are typically larger than 3.0 microns. However, as most pathogenic bacteria are under 1.0 micron in size, most ceramic filters are not effective or suitable for removing bacteria. As the flow path of the water is designed to be torturous, the hope is that weak surface interactions such as Van der Waals forces will trap the particles somewhere along the surfaces of the flow paths before they are flushed from the bed. Monolithic filters such as carbon blocks and ceramic filters employ this type of filtration mechanism for particles. This technology is less desirable from a reliability standpoint than techniques that mechanically screen the particles from the water.

Monolithic filters possess marked problems in terms of weight and capacity for a given applied pressure, limiting their application in portable treatment devices. Thus, use of a portable hydration pack with a drinking tube for water delivery from the pack to the mouth, had to rely on pretreated water. The means to use an on-demand filter for the biological treatment of water from a hydration pack or gravity-fed reservoir did not exist.

A preferred approach to providing for more surface area within a small volume is to employ hollow fiber membranes as the filtration media for size exclusion. The large surface to volume ratio of the hollow fibers greatly increases the area available for contact with the bulk fluid phase, but even with the application of these membrane bundles, the pressure drop across a filter capable of being deployed in a portable filter is substantial. For hollow fiber bundles of the approximate dimensions 7.3 Cm in length and 3 Cm in diameter, such as that produced by Spectrum Laboratories, the flow rate through the bundle under pressures capable of being effectively supplied by sucking on a tube is fairly low. At an applied pressure of 10 psi, the initial flow rate through such a bundle is around 12 mL per second. Any blockage or other restriction to the flow of water through the membrane bundles results in even slower flow rates; possibly low enough to no longer be acceptable in actual usage. A hydrophilic hollow fiber membrane is employed to minimize the resistance to flow of water.

In selection of hollow fiber bundle technology over monolithic block approaches, a major concern with the blocks is the potential for microbial break-through or grow-through occurring as increasing volumes of fluid are passed through the monolithic filter. Because of the surface loading and pressure drop restrictions mentioned above; these monoliths must employ larger effective pore sizes than high surface to volume ratio materials such as the hollow fiber membranes. The potential for failure is clearly higher in the monolithic filters, which for carbon blocks purported to be designed for removal of microbes have mean pore sizes in the neighborhood of 10 microns. The monoliths are often reported to have a capacity of as much as 100 gallons, further raising concerns about bacteria and protozoa being washed from the device. In contrast, the hollow fiber membrane fibers typically have a mean pore size around 0.2 microns with a range between 0.1 and 0.3 microns. Actual capacities of up to 75 gallons or more are possible for membranes formed into a “U” configuration with overall dimensions of 1 inch in diameter and 2.25 inches in length. Water quality and membrane surface area have a marked effect on the capacity of the filter.

A consequence of the use of hydrophilic hollow fiber membranes in hydration pack applications is that if air accumulates inside the membrane housing between uses, a percentage of the suction applied to the filter must be used to expel air from the filter. Because in this type of membrane the air vents by entrainment in water being drawn from the reservoir, if no water remains in contact with the membrane surface the pressure required to purge the filter of air greatly increases.

### BRIEF SUMMARY OF THE INVENTION

Innova Pure Water has through the following invention, greatly minimized the problem of air obstruction by enclosing the axially joined filter elements (the hollow fiber bundle and carbon element) within an impervious shroud, and using the hollow core of the carbon element to channel water to the membrane surface. Water draining from the filter housing is minimized by restricted air flow through the bite valve normally employed in hydration packs (to prevent water from leaking out when not in use) and the hydrostatic pressure of the water remaining in the reservoir, but under certain conditions (such as when the filter is oriented horizontally while the reservoir is drained of water) only a small amount of water may remain within the filter housing. The hollow core of the carbon element acts like a straw, to allow the remaining water to funnel up and spray the membrane surface when suction is applied. This transitory wetting of the membrane is normally sufficient to allow enough air to be vented to reestablish the flow of water through the filter. The invention allows for the use of hydrophilic membranes exhibiting lower pressure drop with water, while providing for an inexpensive means of venting trapped air from the filter. If the water level in the filter housing should become so low that even the channeling of water to the membrane fails to allow resumption of flow, simply having the user lean against a support to provide additional pressure within the reservoir will clear the air from the element.

It is critical to remove bacteria as well as protozoa. Many water born diseases, including some of the most serious, are caused by bacteria or protozoa in the water. Viral diseases are not easily amenable to removal via filtration, and are normally controlled through the use of chemical disinfectants. In employing media with effective pore sizes appropriate for microbial removal, the pressure drop from the container through the filter and out to the user approaches 10 psig toward the end of the useful life, deemed a practical limit of usability for the average person. Antimicrobial filter systems typically also incorporate activated carbon for the removal of chemical species from the water. When organized as separate independent structures, the tendency of these carbon elements to become fouled with particulates need not be as great as the element used for microbial removal. To maintain the lowest pressure drop independent filters should be used that are separately installed and complement one another. The principal advantage to maintaining separate filter elements with differing useful lives is that each can be replaced independently, depending upon need. It is also desirable to add an optional pre-filter that is preferably separately removable and cleanable, particularly in area where high-silt water is encountered.

Innova has now developed a superior approach permitting the very effective removal of bacteria, as well as protozoa, while retaining the ability to independently integrate a carbon composite, or other filter. The present invention extends the life and use of the biological filter element, by utilizing a hollow fiber membrane (HFM)—preceded by a monolithic carbon pre-filter. While the membrane bundle may only be two—three inches in length and one inch in diameter as much as a square foot, or more, of membrane area exists. Thus, while the effective pore size is between 0.2-0.3 micron (with 0.5-0.15 micron preferred), the pressure drop remains from 1-2 psi to under 10 psi over the useful life. The filter assembly includes a complementing high performance carbon composite—zeolite element with an average pore size between 10-50 microns (with a preferred pore size of 15-20 microns), capable of removing greater than 50% of the chlorine and greater than 90% of lead at a flow rate of 10 mL/sec. Thus, by combining the HFM with the carbon composite filter, protozoa, bacteria, lead, chlorine, taste and odor are removed. Other metals and chemical contaminants are likewise reduced. An optional screen, or depth filter may be added for silt removal and to extend the life of the other elements by reducing materials that would normally cause either or both filters to eventually clog. The screen and pore size may be from 6-40 microns, with seven to eight generally preferred.

The design is not self-venting, thus it is necessary to incorporate a water reservoir that will shrink after supplying water to the filter, or a means to vent air. The venting is controlled by a one-way valve, which allows air to enter the bottle replacing the expelled liquid, but precludes the passage of the water (liquid) from the container except the valve installed for that purpose. Valving is not required for soft containers such as hydration packs. Typically, a hose connects the filtration unit to the water reservoir as well as to the mouth bite valve. Drinking is typically accomplished by opening the mouth bite valve and sucking. In an alternative design a small hand-pressurizing pump is incorporated within the filter housing that can aid in water delivery through the filter, or alternatively be used as a means to pick up water from a ground source.

It is further recognized that there are three distinct classes of biological contamination: protozoa cysts, bacteria, and virus. Protozoa are typically larger than 4 microns; bacteria are generally larger than 0.2-0.3 microns, both of which may be filtered out. The third form of biological contamination found in nature consists of virus; which are usually chemically devitalized, as they are too small to be filtered out by most practical portable mechanical means.

Viral contamination can be a major problem in remote areas where only stagnant water, or water contaminated by poor sanitation may be available. In the instances of natural disaster, as well as in the developing world, viral pestilence in the only available water can represent a life-threatening problem. Thus, it is necessary for a water treatment product to be capable for use with all waters possessing potential biological problems. To the degree possible, it is also desirable to provide a foolproof means of viral devitalization as necessary. Internationally, Innova recommends the use of a “chlorine” tablet that is added to the raw water container for devitalization of virus that may be present. The pre-filter, which is exceptionally effective at the removal of chlorine, removes the residual chlorine to levels below the taste threshold thus providing clean good tasting biologically safe water to the user. This carbon first stage element also acts to remove some particulate matter and protects the hollow fiber membrane from damage by the disinfectant.

The hollow fiber membrane for removal of protozoan cysts and bacteria from water, combined with a pre-filter in an “in-line” design, has wide application for use with canteens and hydration packs as well as gravity-fed water bags. For maximum utility it is desirable to maintain the greatest degree of flexibility, and thus the filtration element is a separately housed and contained assembly with independent water inlet and exit ports. Each port is equipped with a barb or smooth hose fitting, thread on coupling, quick disconnect or other simple and effective means of securing hoses to both the “in” and “out” ports of the filtration unit as well as to the water source or container. Preferably, the “in-line” design incorporates a carbon filter to compliment a sub-micron hollow fiber micron filter. Alternative designs can utilize the filter assembly within the flexible reservoir itself, rather than connected externally.

Applications of this nature rely upon either suction by the user or gravity, or a combination of gravity and siphon action, to pressure the water through the filtration elements. Typically, the separate container of water is not squeezed or otherwise pressurized to effect water transfer. However, should it be necessary to use pressure to enhance the flow of water, there are several ways that it could be accomplished.

Typically, the housing with water inlet and outlet ports consists of a secondary filter housed HFM bundle to which may be attached a primary carbon composite filter. Alternately, a non-woven carbon cloth depth filter or fine mesh 10-micron screen may be used as a pre-filter being assembled over or ahead of the carbon filter for particulate matter removal. The screen filter may also replace the monolithic carbon primary filter while reducing size and weight when chlorine and chemical removal is not a consideration. Regardless of the primary filter element used, all elements are independently replaceable.

The carbon composite filter is of a radial flow nature and nominally of 20-micron pore size. The hollow fiber filter may have pores as small as 0.1-0.2 micron and reject particles from 0.05-0.2 micron and larger sized particles as a result of the wall thickness of the membrane. As an alternative, the design also lends itself to the use of granular activated carbon combined with ion exchange resins and other treatment media. A third alternative when space and weight become extremely critical is to use a carbonized non-woven cloth as a complementing filter element.

While normally designed for use with water for the removal of specific chemical and all microbiological contaminants, excluding virus, the in-line system may be used as an emergency air purifier, as long as the unit has not been used to treat water.

The low sub-micron capability of the HFM filter as well as the carbon composite element have the capability of removing a host of both chemical and biological contaminants from protozoa through bacteria to the standards established by the EPA for the removal of these biological contaminants.

One advantage of the disclosed design is flexibility. It may be used in conjunction with various hydration packs, such as popularized by CamelBak. The biological filter may be housed within the outer carrying cloth case of the hydration pack or used externally inserted into the water delivery line of the pack or function internally within the water bladder or container. The unit may be connected to the drinking tube in a gas mask. It may also be connected externally to a canteen permitting drinking from the canteen through the filter by means of a tube. The filter may be suspended between two containers during water transfer permitting gravity and/or siphon action to transfer the water through the filter thus effecting the treatment of a significant quantity of water, such as five gallons, or as may be desired. A hand operated bulb pump or piston may be incorporated to permit water to be drawn from a stream filling the chosen canteen, pack, or receptacle with filtered water.

The housing may be adapted to integrate directly with a hand pump to feed water through the in-line filter elements for treatment. Typically, a hand operated piston pump is threaded onto the housing containing the previously described filter elements. The treated water may be directed into any container, or into a hydration pack to which the in-line filter is normally assembled. However, to use as and with a filter-on-filling device the filter is removed from the hydration pack drinking tube to which it is normally attached, and reversed. It is then reassembled to the tube connected to the hydration pack, and the unconnected end is unthreaded and the pump threaded on. The unit is then ready to treat water from an available source and force the treated water into the container. A water pick-up tube is attached to the pump element.

In a similar fashion the housing may be adapted to contain a reverse osmosis membrane to desalinate water and feed the treated water into a hydration pack or the like.

### BRIEF DESCRIPTION OF THE DRAWINGS

These and other aspects and advantages of the present invention will be described in detail with reference to the accompanying drawings, in which:

FIG. 1 shows an in-line combination hollow fiber sub-micron membrane filter with separate independent carbon composite monolithic filter for adaptation to hydration pack or suspended camp water container;

FIG. 2 shows an in-line hollow fiber membrane filter with separate independent prefilter screen;

FIG. 3 shows an in-line hollow fiber membrane filter with separate independent carbon fiber pre filter discs, and shortened housing;

FIG. 4 shows an in-line combination hollow fiber sub-micron membrane filter with separate independent carbon composite monolithic filter with bulb pump to pressurize and aid water flow;

FIG. 5 shows an in-line combination hollow fiber sub-micron membrane filter with separate independent granular activated carbon filter;

FIG. 6 shows an in-line sub-micron filter with carbon prefilter cap mounted for assembly onto a hydration pack or larger camp water supply;

FIG. 7 shows an in-line sub-micron filter with carbon prefilter cap mounted for assembly onto a suspended larger camp water supply;

FIG. 8 shows an in-line filter with air permeable relief ports;

FIG. 9 shows an in-line combination hollow fiber sub-micron membrane filter with separate independent carbon composite monolithic filter incorporated with hand pumping device;

FIGS. 10 and 10A show an adaptation of in-line filter housing and hand pump incorporating a reverse osmosis membrane;

FIG. 11 illustrates use of in-line filter in hydration pack with adjustable heating elements to preclude water from freezing.

### DETAILED DESCRIPTION OF PREFERRED EMBODIMENTS

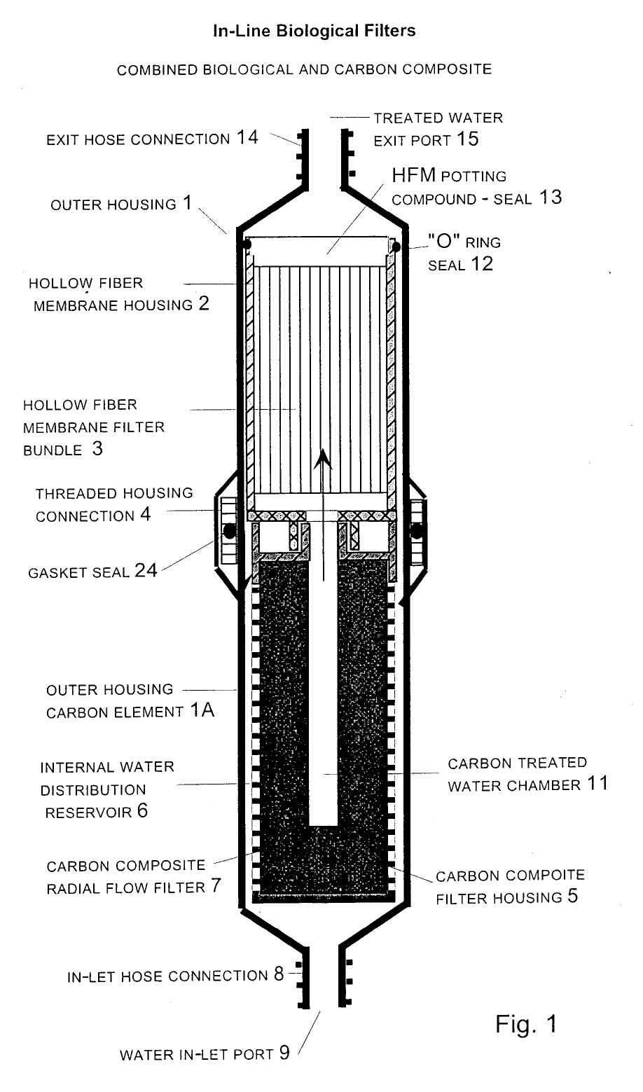

FIG. 1 shows the in-line filter design employing a sub-micron hollow fiber membrane 3, with an independent carbon composite filter 7 for use with an independent water source and, typically, a drinking tube which would be connected at 4. There is no means to pressure the water through the in-line filters, as they are typically integrated with a water source by way of a hose connecting at 8, which would be attached to a water source, typically a hydration pack, canteen, or water bag unless an ancillary hand pump is added. The water source will independently have the means to equalize pressure for the removal of the water from the container. Outer housings 1 and 1A support the primary carbon composite filter 7 and secondary hollow fiber membrane filter 3. The housings are connected together by threaded connection 4, compressing gasket seal 24. An “O” ring seal 12 seals the hollow fiber membrane against the outer housing 1, to preclude by-pass of untreated water. Water enters through in-let port 9 and fills the internal water distribution reservoir 6. The water is drawn radially into the louvered housing 5, through the carbon composite filter 7, into the center treated water chamber 11. The water treated by the primary filter passes through the independent filter connector 10 into the outer housing 2 of the hollow fiber membrane filter bundle 3, then transfers through the walls of the membranes 3 and exits from the hollow center of the membranes 3, at the top of the potting compound seal 13, and exits post treatment through port 15, typically into a hose or tube connected at 14.

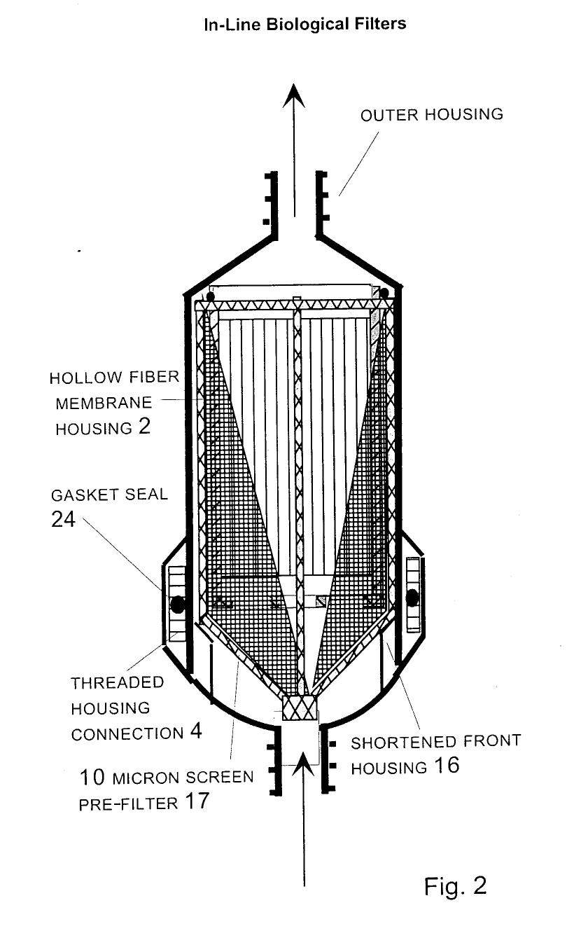

FIG. 2 is identical to FIG. 1 with the exception that the pre-filter 17 is a 10-micron screen that fits over the hollow fiber membrane housing 2, and may be removed for cleaning. Shortened front housing 16 attaches to outer housing 1 at threaded connection 4 compressing gasket seal 24 and retaining screen 17 in position.

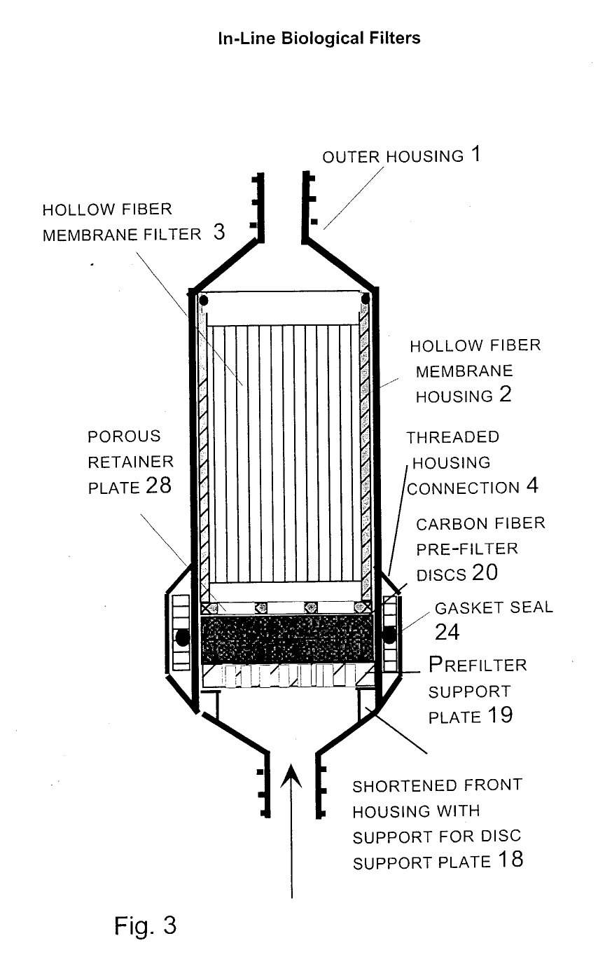

FIG. 3 contains the same HFM biological element 3, as FIGS. 1 and 2 but employs a number of activated carbon cloth filtration elements 20, in the form of cut discs as prefilter elements and to aid in the reduction of chemical disinfectants, if present, as well as to reduce unpleasant taste and odors that may be present in the raw water. The carbon discs 20 are arranged to provide axial flow filtration through the carbon elements 20. Shortened front housing 18 provides support for support plate 19. Top porous retaining plate 28 supports and compresses the carbon prefilter discs 20, and separates the carbon discs 20 from the hollow fiber membrane housing 2. Outer housing 1 and front housing 18 are threaded together at 4, compressing gasket 24 effecting a seal.

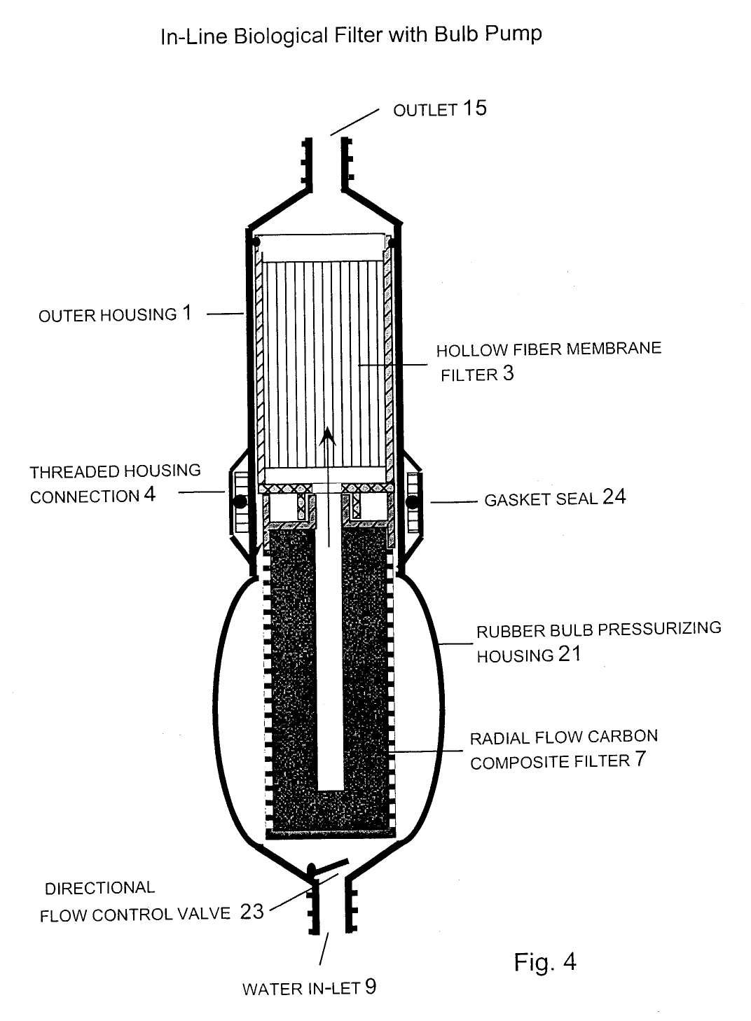

FIG. 4 is identical to FIG. 1 with the exception that the water inlet 9 outer housing 21 is an elastomer, permitting the bulb shaped elastomer housing 21 to be squeezed to pressurize the water through the carbon composite filter 7. A flow control valve 23 allows water to be drawn from the source container, or a river or such, and forced through the filter elements 7 and 3, exiting through treated water outlet port 15. Outer housing 1 is joined to the bulb pressurizing housing 21 by means of threaded tensile connection 4, compressing gasket 24 to form a water tight seal.

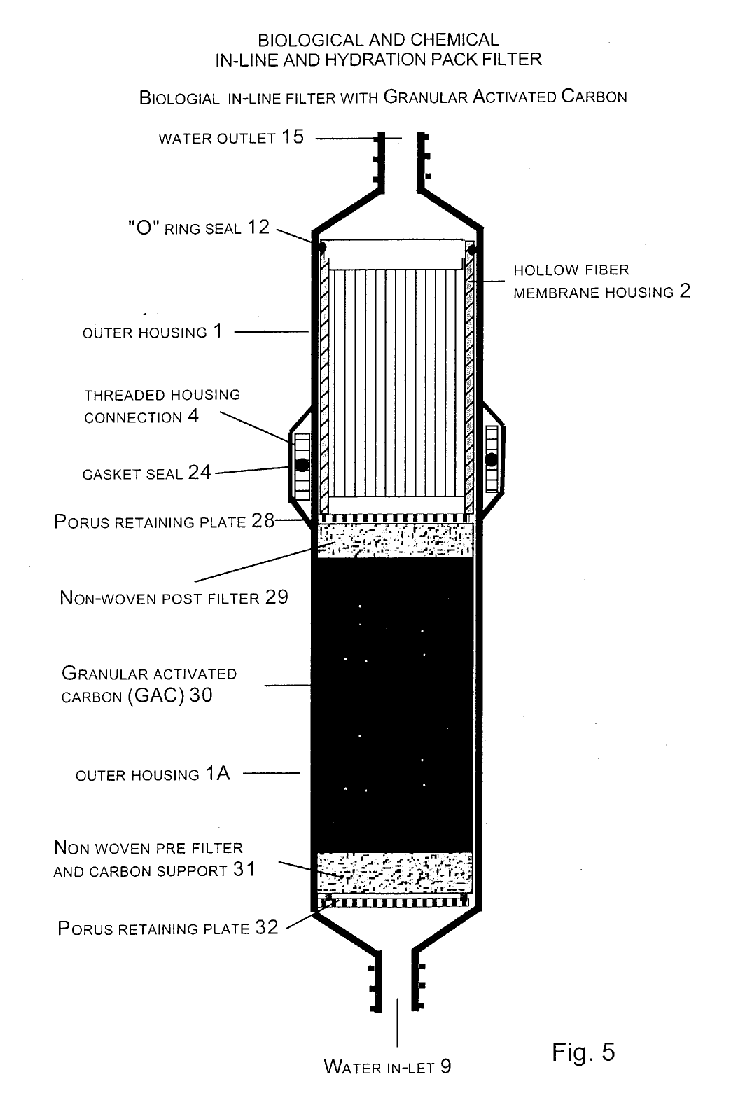

FIG. 5 is similar to FIG. 1, but incorporates a granular activated carbon filter (GAC) 30, which may be mixed with other treatment medias such as ion exchange resins to address unique problems of contamination. The GAC filter 30 is an axial flow filter supported and held in place by non-woven prefilter element 31, which in turn is held in place by the porous retaining plate 32, positioned by the outer housing 1A containing water inlet port 9. At the water exit end of the GAC bed 30, non-woven post filter element 29, is compressed against porous retaining plate 28, which in turn supports and retains hollow fiber membrane housing 2, with O-ring seal 12, within outer housing 1, containing water outlet 15. Outer housing 1 is attached to outer housing 1A by threaded tensile connection 4, compressing gasket 24 to effect a water tight seal.

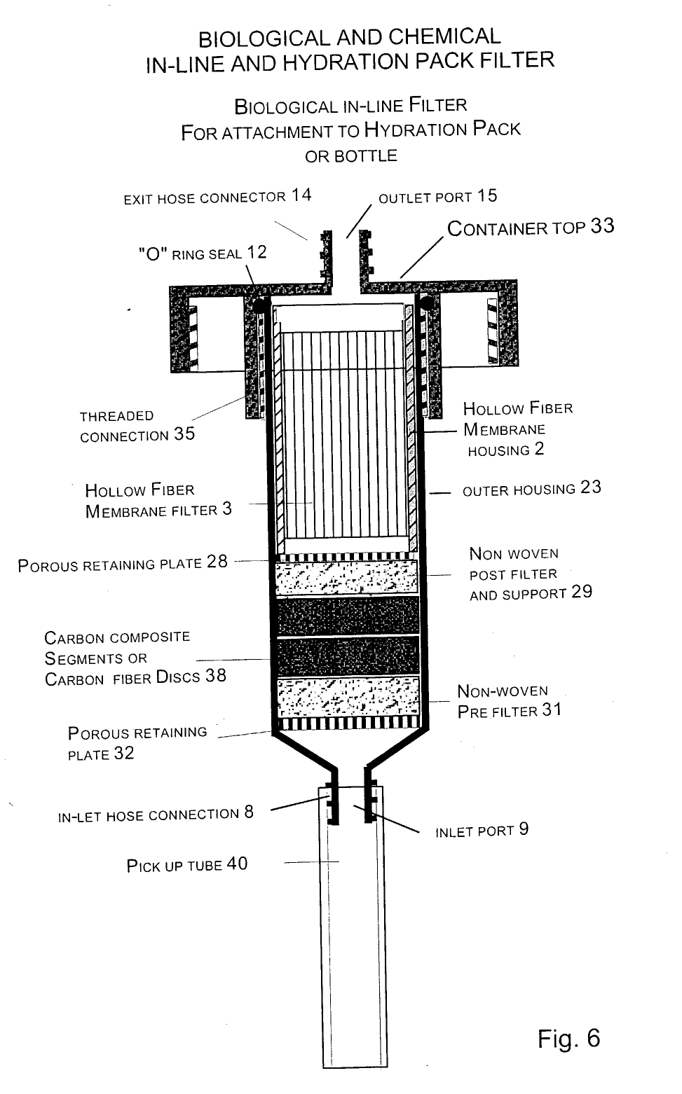

FIG. 6 shows a different application of the combined biological filter 3, and carbon composite filter discs 38. In this application of the technology, the filter assembly 3, 38 is assembled to a container top 33 by means of a threaded connection 35, which is an integral component of the outer housing. The entire filter assembly is submersed within the container from the threaded container top 33. There is a water pick-up tube 40 attached to the outer housing 23 by the hose connection 8. As the water enters the filter assembly it passes through a porous prefilter support plate 32 retained in position by outer housing 23. The water then passes through the non-woven pre-filter 31, hence through the carbon composite filter, or carbon fiber discs, 38, then through a non-woven post filter 29, and a porous retaining plate 28, supporting the hollow fiber membrane housing 2 with O-ring seal 12, and hence through the hollow fiber membrane filter elements 3, exiting through the outlet port 15, and hose connection 14, the hose to which would lead to a mouth bite valve (both of which are not shown).

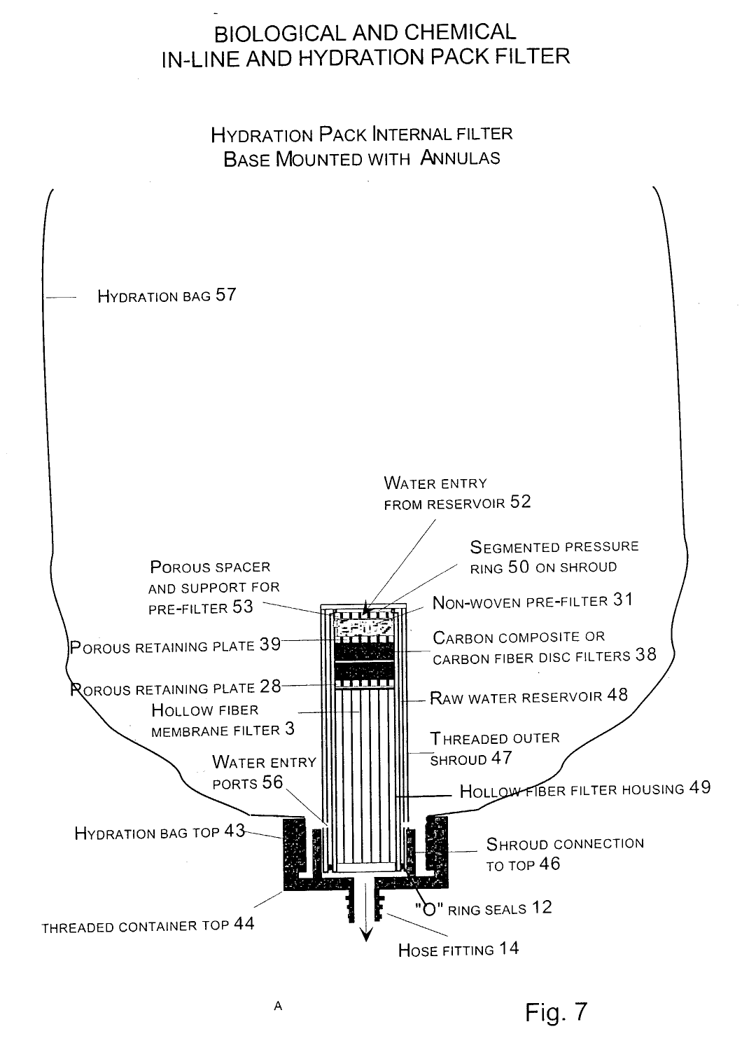

FIG. 7 is somewhat of an opposite approach to FIG. 6 above. While the components are primarily the same, one additional major component has been added. In this configuration, a threaded outer shroud 47 is used. The outer shroud 47 has water entry ports 56, which allow water to enter when the pressure is reduced by suction or by head pressure. The water then is drawn into the raw water reservoir 48 and is drawn up, as in a straw, entering the filtration components from the reservoir 48, through the porous support spacer 53, hence through a single non-woven prefilter element 31. The water then flows axially through porous retaining plate 39, into a carbon filter consisting of a composite, or multiple carbon fiber disc filters 38. The filtration media is compressed and held in place by the porous retaining plate 28 which may be molded in as an integral component of hollow fiber membrane housing 49. An “O” ring seal 12 precludes leakage past the hollow fiber membrane housing 49. The shroud 47 threads to the threaded connection 46, molded into the container top 44, and abuts onto O-ring 12. A segmented pressure ring 50, is molded into the base of the shroud 47 retaining porous spacer 53, in position. The entire assembly is held in place to the hydration bag or water bottle 57 by the top 44 which threads to the hydration bag top 43. The treated water exits through the hose fitting 14. The hose when assembled would typically lead to a mouth bite valve for the delivery of water under both head pressure or pressure generally developed by sucking. Alternatively, the treated water may be delivered to a second container by gravity from a suspended container 57.

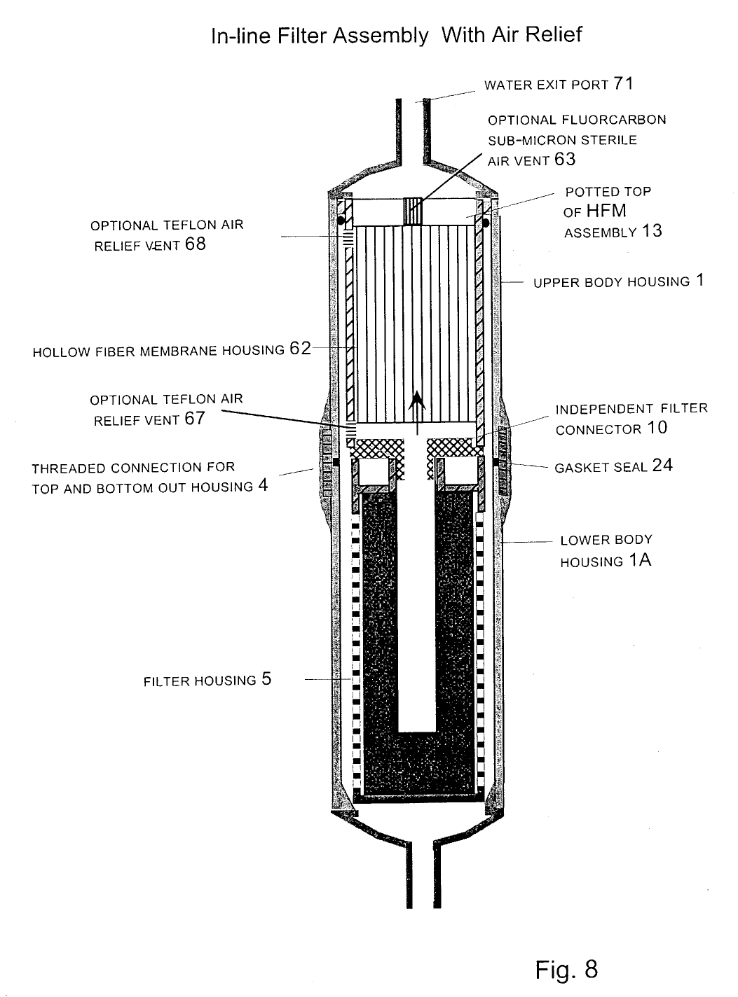

FIG. 8 is an in-line filter assembly as shown and described in FIG. 1, with the additional optional feature of a small fluorocarbon submicron pore vent 68, 67 and 63, in the hollow fiber membrane housing 62. These hydrophobic vents will pass air but not water at the pressures developed. Optional fluorocarbon sub-micron sterile air vent 63 is mounted directly into and through the center of the potted end portion of the hollow fiber membrane bundle 13, to relieve any entrained air that may become trapped within the membrane bundle. The fluorocarbon vents possess small micron pore size that will pass air but not water considering the very small pore size as well as the hydrophobic nature of the fluorocarbon. An independent filter connector 10 is used to assemble the two filter elements 62, 5 together. The filter assemblies are retained in position within upper and lower body housings 1, 1A threaded together at 4 compressing the watertight gasket seal 24.

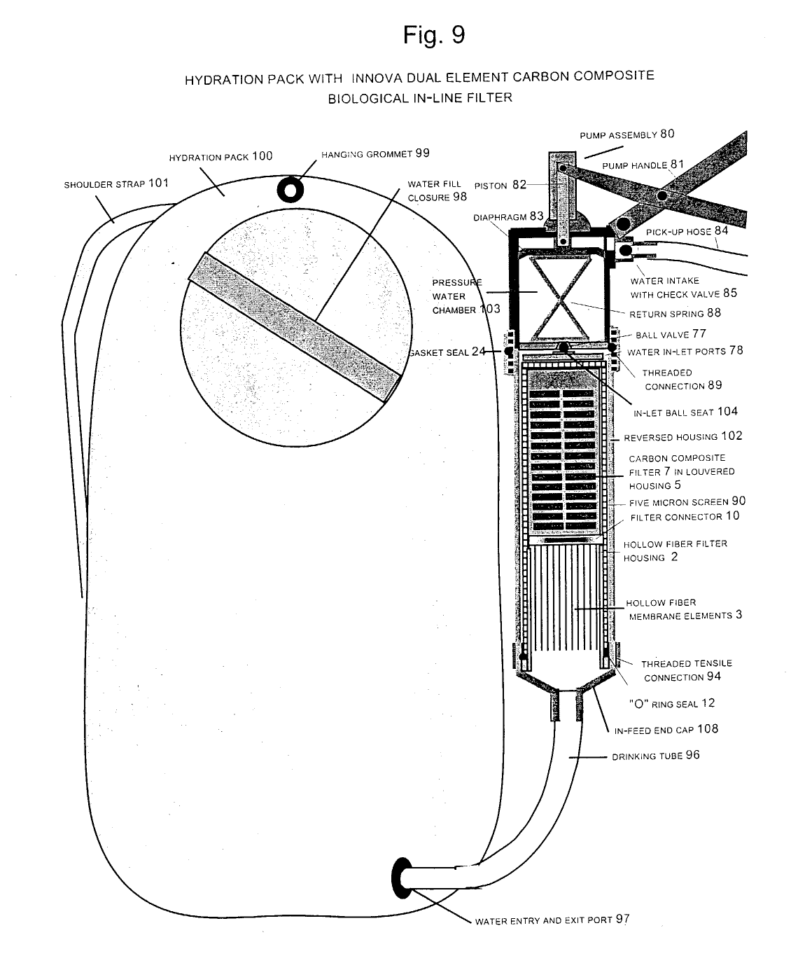

FIG. 9 uses the same basic filter elements as described in FIG. 1 but with the in-feed, exit ports reversed to treat water prior to filling a hydration pack or container. To do so the filtration unit is used in conjunction with a pump assembly 80, to both draw water from a source by means of a pickup hose 84, feeding through in-take valve 85 to fill a hydration pack 100, with treated water, using the lower half of the drinking tube 96 as an in-feed tube. The pump 80 is assembled to the outer housing 102 at threaded connection 89, compressing gasket seal 24. The pick-up hose 84 is inserted into a water supply. As the pump handle 81 is squeezed, the piston 82 and diaphragm 83 are moved to the base of the cylinder pressure chamber 103, forming a vacuum in the chamber 103, causing water to be drawn up through the hose 84, passed water in-take check valve 85, and into the chamber 103. When the piston 82 and diaphragm 83 retract under spring pressure 88, the water moves passed the diaphragm 83, which partially collapses as a result of its cupped shape filling the chamber 103 ahead of the diaphragm. When the pump handle 81 is squeezed, the water is forced through the ball valve 77 and water in-let port 78, through the 5 micron prefilter screen 90, then through the louvered filter housing 5, into the closed end radial flow carbon filter element 7. The center of the carbon element 7, excepting the closed end, is hollow allowing the filtered water to pass through the filter connector 10, providing a watertight seal between the filter element housings 5, 2. The water enters the hollow fiber membrane housing 2, and then enters the individual hollow fiber elements 3, the fully treated water exiting through the end cap 108 into tube 96. The filter body consists of the housing 102, end cap 108, with threaded connection 94, within which is “O” ring seal 12. The other end of the housing 102 is threaded at connection 89 to the pump assembly 80. For reference purposes, a hydration pack 100 is shown containing a standard fill port with closure 98, a hanging grommet 99, and shoulder strap 101.

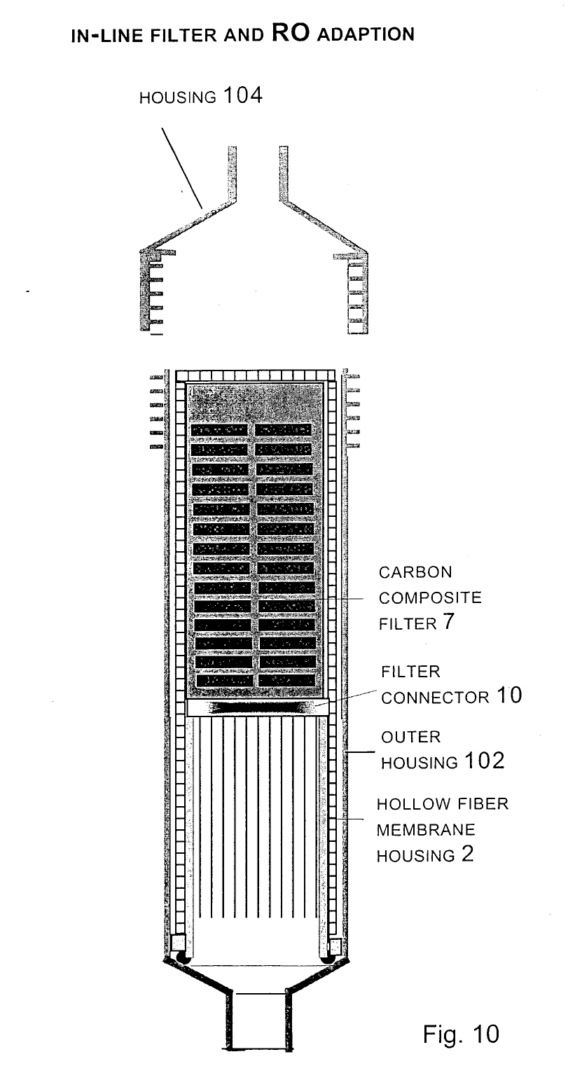

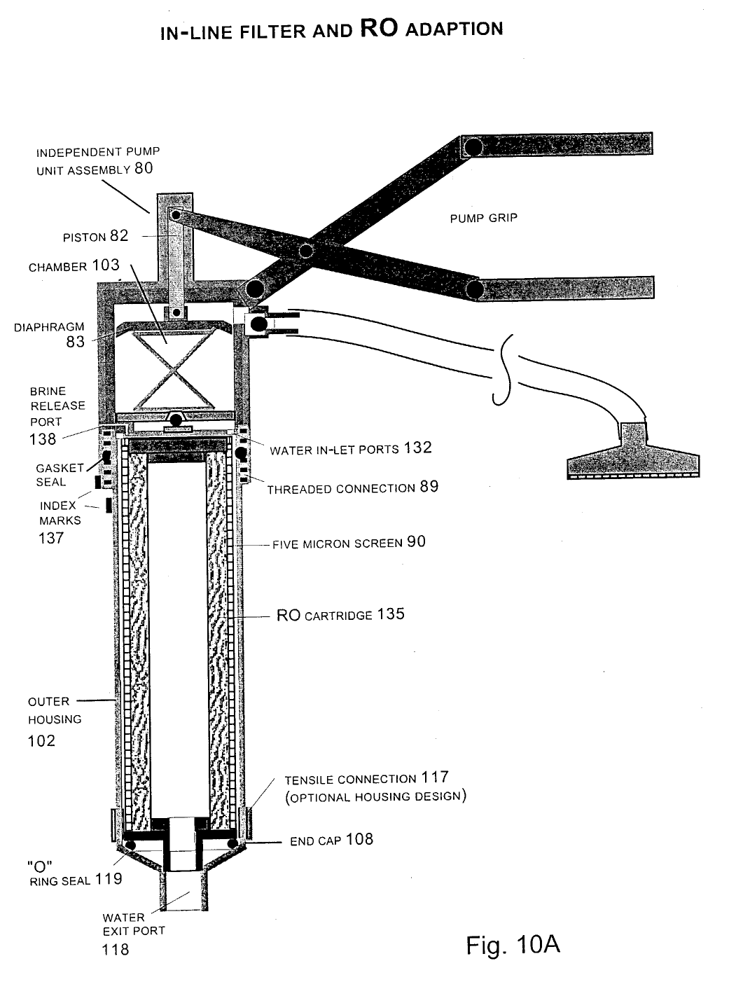

FIGS. 10 and 10A show a similar application; however, rather than using the hollow fiber membrane and carbon composite filter elements, a reverse osmosis (RO) cartridge 135 is used. Using a similar pump unit 80, as described in FIG. 9, the filter elements as shown on FIG. 10; housing 104, radial flow carbon composite filter 7, hollow fiber membrane filter 3, and filter connector 10, are removed from filter housing 102. The reverse osmosis membrane cartridge 135 is inserted into the filter housing 102, as is the optional pre-filter screen 90. The RO membrane assembly 135 when inserted nests against the base end cap 108, compressing O-ring seal 119. The pump assembly 80 is threaded onto the filter housing 102 making a threaded connection at 89, compressing gasket 24. The housing 102 and pump assembly 80 are aligned with an index mark 137 providing an exit for the brine created. The operation otherwise is the same as described for FIG. 9, with treated desalinated water exiting through the water exit port 118 in end cap 108. An optional design for the end cap 108 permits it to be a separate component threading to the housing 102 at the point of tensile connection 117.

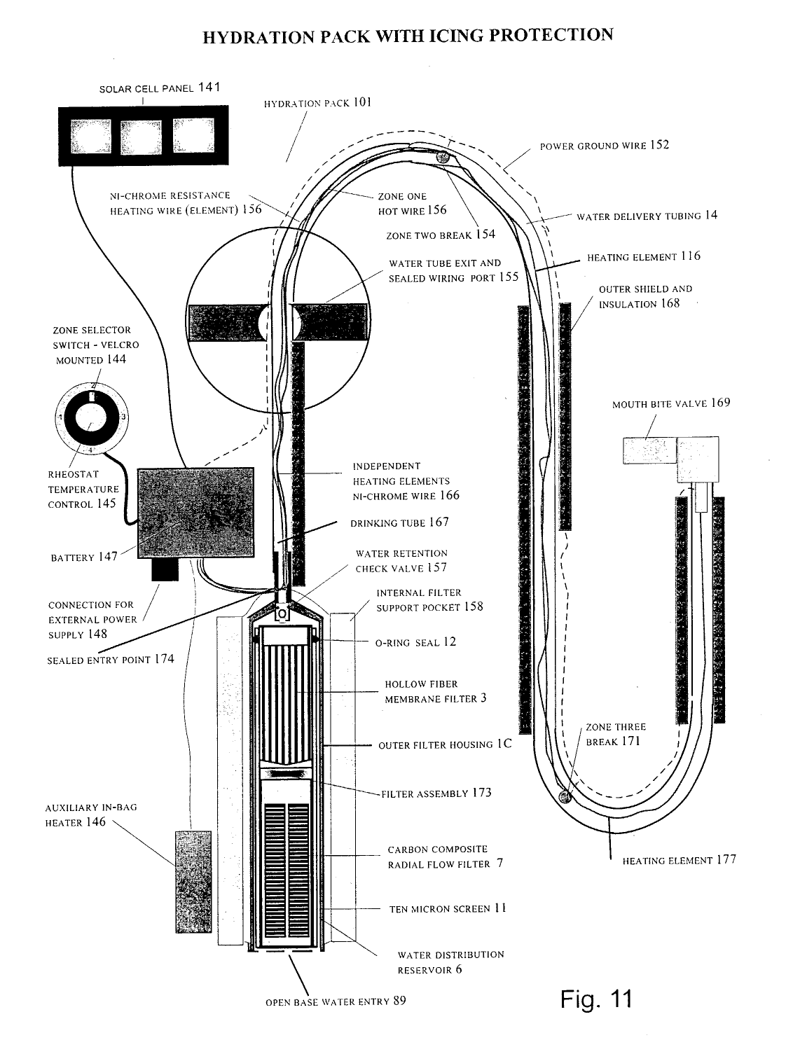

FIG. 11 represents the placement of a filter assembly generally as described in FIG. 1, the major components of which include outer filter housing 1, carbon filter element 7, hollow fiber membrane filter 3, O-ring seal 12, ten micron pre-filter screen, water distribution reservoir 6, and a revised open base for water entry 89. This assembly is held in position inside a hydration pack within an open internal filter support pocket 158 positioned at the base of the hydration pack 101. A drinking tube 167 extends from the filter assembly 173. The water retention check valve 157 precludes water from draining back into the pack during periods of non-activity. The water delivery tube 14 exits the hydration pack 101 at sealed exit port 155. The water in the tube is kept from freezing in cold weather by means of NiChrome heating wires 166, which enters the tube at sealed entry point 174. The power for heating is delivered by a battery 147, which is recharged by solar panels 141, or through the external power supply connection 148, with the temperature regulated by means of rheostat 145. The rheostat has a zone selector switch 144, which permits the selective heating of the various elements, depending upon conditions. Within the hydration pack is a heating element 146 to retain the temperature in the bag above freezing. The selector switch 144 controls this heater. The drinking tube is zoned with separate heating elements 156, 116, and 173, which are independently regulated heating elements passing through zone breaks 154, 177. At each zone break a connection is made with the ground wire 152 to complete the circuit. The ground or return wire 152 is encased within the outer insulating shield 168. The water is kept from freezing through delivery to the bite valve 169.

The following represent independent tests of the HFM product: Cryptosporidium Surrogate: Bangs Laboratory 3.0 micron microspheres (supplied by NSF International) ¹Testing performed by Dr. Debra Huffman at the University of South Florida Department of Marine Sciences.

Water: St. Petersburg, Fl. tap water

| | Average Influent | Average Effluent | |
|---|---|---|---|
| | Concentration | Concentration | Percent |
| Innova filter | Spheres/mL | Spheres/mL | Removal |
| C₁ | 521 | <0.03 | >99.9936 |
| C₂ | 521 | <0.03 | >99.9936 |

Bacterial endospores: Bacillus globigii

Water: dechlorinated St. Petersburg tap water

| | Volume | | | |
|---|---|---|---|---|
| | of Test | | | |
| | Water | Average Influent | Average Effluent | |
| Filter | Filtered | Concentration | Concentration | Log₁₀ |
| Designation | (liters) | CFU/100 mL | CFU/100 mL* | Removal |
| NT₂ | 300 mL | 6.5 × 10⁷ | 0.5 | 8.1 |
| NT₃ | 300 mL | 6.5 × 10⁷ | <0.5 | >8.1 |

*Averages based upon replicate 100 mL volumes

Bacteria: E. coli (ATCC #15597)

Water: deionized MilliQ water

| | Average Influent | Average Effluent | |
|---|---|---|---|
| | Concentration | Concentration | Percent |
| Innova filter | CFU/mL | CFU/mL | Removal |
| C₁ | 1 × 10⁵ | <0.1 | >99.9999 |
| C₂ | 1 × 10⁵ | <0.1 | >99.9999 |
| C₃ | 1 × 10⁵ | <0.1 | >99.9999 |
| C₄ | 1 × 10⁵ | <0.1 | >99.9999 |
| CT₁ | 1 × 10⁵ | <0.1 | >99.9999 |

Bacteria: Klebsiella terrigena

Water: dechlorinated St. Petersburg tap water

| | Volume of | Average | Average | | |
|---|---|---|---|---|---|
| | Test Water | Influent | Effluent | | Meets |
| Filter | Filtered | Concentration | Concentration | | EPA |
| Designation | (liters) | CFU/mL | CFU/mL | Log₁₀ Removal | Guideline |
| Innova Pure | 3.2 | 1.2 × 10⁵ | <0.01 | >7.0 | Yes |
| Water | | | | | |
| Biofilter | | | | | |

Quoting Dr. Huffman:

“This exploratory research reveals the ability of the Innova filters to effectively remove latex spheres the size of Cryptosporidum oocysts, bacterial endospores that are within the size range of Bacillus anthrasis spores, and vegetative bacterial cells.

The Innova filters meet the performance requirements for bacteria and protozoa in the EPA Guidance Standard for Microbial Removal, for the sample points examined. The standard requires 99.9999% (6 log) removal of Klebsiella terrigena bacteria and 99.9% (3 log) removal of protozoan cysts, during this laboratory testing the Innova filter exceeded that level of performance.”

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A portable filtration assembly comprising:
a housing containing a water inlet port and a water outlet port;
a sub-micron filter disposed in the housing and including hydrophilic sub-micron rated membrane filter elements, the sub-micron filter being configured to effect a six log reduction of bacteria (99.9999%) and a four log reduction of protozoa (99.99%) at a flow rate between 10-30 mL/sec requiring a pressure of 1.5-10 psi; and
means for venting air through the hydrophilic sub-micron rated membrane filter elements.

2. A portable filtration assembly according to claim 1, further comprising a monolithic radial flow carbon composite filter disposed in the housing, the monolithic radial flow carbon composite filter being configured for removing at least 80% of chlorine and at least 90% of lead over a minimum of forty gallons at a flow rate of 10 mL/sec at a pressure drop of 10 psi or less.

3. A portable filtration assembly according to claim 2, wherein the venting means comprises a funnel in a center of the monolithic radial flow carbon composite filter that funnels water contained within the assembly to a surface of the hydrophilic sub-micron rated membrane filter elements.

4. A portable filtration assembly according to claim 2, further comprising a pre-filter element disposed in the housing upstream of the sub-micron filter.

5. A portable filtration assembly according to claim 4, wherein the pre-filter element comprises a fine mesh screen.

6. A portable filtration assembly according to claim 2, wherein the sub-micron filter and the monolithic radial flow carbon composite filter are independently replaceable.

7. A portable filtration assembly according to claim 2, wherein the assembly is configured to effect treatment of 20-100 gallons of water with a pressure drop across the assembly of 10 psi or less with an average turbidity factor of less than 1 NTU.

8. A portable filtration assembly according to claim 2, further comprising an attachment component coupled with one of the water inlet port and the water outlet port.

9. A portable filtration assembly according to claim 8, wherein the attachment component comprises means for pressurizing the assembly.

10. A portable filtration assembly according to claim 2, further comprising a battery-powered heat source cooperable with the assembly.

11. A method of filtering water comprising:
flowing water through a sub-micron filter disposed in a housing and including hydrophilic sub-micron rated membrane filter elements, the sub-micron filter being configured to effect a six log reduction of bacteria (99.9999%) and a four log reduction of protozoa (99.99%) at a flow rate between 10-30 mL/sec requiring a pressure of 1.5-10 psi; and
venting air through the hydrophilic sub-micron rated membrane filter elements.

12. A method according to claim 11, further comprising additionally flowing the water through a monolithic radial flow carbon composite filter disposed in the housing, the monolithic radial flow carbon composite filter being configured for removing at least 80% of chlorine and at least 90% of lead over a minimum of forty gallons at a flow rate of 10 mL/sec at a pressure drop of 10 psi or less.
